(19) United States
(12) Patent Application Publication
(10) Pub. No.: US 2013/0219913 A1
(43) Pub. Date: Aug. 29, 2013

(54) GEARED TURBOFAN GAS TURBINE ENGINE WITH RELIABILITY CHECK ON GEAR CONNECTION

(71) Applicants: Michael E. McCune, Colchester, CT (US); Frederick M. Schwarz, Glastonbury, CT (US)

(72) Inventors: Michael E. McCune, Colchester, CT (US); Frederick M. Schwarz, Glastonbury, CT (US)

(21) Appl. No.: 13/440,085

(22) Filed: Apr. 5, 2012

Related U.S. Application Data
(63) Continuation-in-part of application No. 13/406,635, filed on Feb. 28, 2012, now abandoned.

(51) Int. Cl. F02C 7/00; F02C 3/06

(52) U.S. Cl. 60/779; 60/39.091

(57) ABSTRACT

A gas turbine engine includes a fan and a compressor. A combustor drives a turbine, including a first turbine with a shaft to drive the compressor. A fan drive turbine drives the fan through a speed reduction. A sensor senses a speed of rotation of the fan and communicates sensed speed information to a control. The control develops an expected speed for the fan. A problem is identified should the sensed speed be less than the expected speed by more than a predetermined amount. A method is also described.

### RELATED APPLICATION

This application is a continuation-in-part of U.S. patent application Ser. No. 13/406,635, filed on 28 Feb. 2012.

### BACKGROUND OF THE INVENTION

This application relates to a gas turbine engine wherein a fan rotor is driven through a geared connection, and wherein safety monitoring is performed to ensure that the geared connection has not failed.

Gas turbine engines are known, and typically include a fan delivering air into a compressor. The air is compressed in the compressor and delivered downstream into a combustion section. The air is mixed with fuel and ignited, and products of this combustion pass downstream over turbine rotors.

There are any number of distinct types of gas turbine engines. Two common types are so-called “two spool” and “three spool.”

In a two spool gas turbine engine, there are typically a pair of compressors and a pair of turbines each having singular or multiple stages. A shaft connects a high pressure turbine to a high pressure compressor, and is known as a “high spool.” A lower pressure turbine is connected by a shaft to a low pressure compressor and is known as a “low spool.” The terms “low” and “high” are relative to each other. Historically, the low spool shaft also drives the fan rotor, all at one speed with the low spool.

Another type of gas turbine engine architecture utilizes a third spool. In such gas turbine engines there is also an intermediate spool. A third turbine drives the fan rotor as the “low spool.”

More recently, a gear reduction has been incorporated between the drive shaft of a turbine section and the fan rotor. This feature may be used in two or three spool gas turbine engines.

When a gear reduction is used, a resilient coupling may be provided between the gear train components and the drive shaft and/or the fan shaft. This transmission path provides any number of potential failure points. Should the transmission fail, the fan may no longer be driven. This could prove undesirable, as the speed of the turbine section driving the fan is typically limited by the torque required to drive the fan. Once the connection fails, the turbine section driving the fan could reach undesirably high speeds.

In some respects this concern is magnified for three spool gas turbine engines compared to two spool gas turbine engines. In a two spool engine, if the gear connection to the fan fails, the low pressure turbine is still driving the low pressure compressor, and thus it typically will not reach speeds as undesirably high as might be the case with the three spool design.

### SUMMARY OF THE INVENTION

In a featured embodiment, a gas turbine engine has a fan, a compressor section, a combustor, and a turbine system. The turbine section includes a first turbine having a shaft to drive the compressor, and at least a fan drive turbine. The fan drive turbine is operable to drive the fan through a speed reduction. A sensor senses a speed of rotation of the fan and communicates the sensed speed to a control. The control is operable to develop an expected speed for the fan and identify a problem should the sensed speed be less than the expected speed by more than a predetermined amount.

In another embodiment according to the previous embodiment, the sensor dynamically determines an angular position of a feature rotating with the fan by measuring the time of arrival of the feature. This dynamically determined angular position is utilized as the sensed speed and compared to an expected angular position of the fan feature. The expected angular position is the expected speed.

In another embodiment according to any of the previous embodiments, a sensor is associated with the fan drive turbine to sense the angular position of a feature on the fan drive turbine. The sensed angular position of the fan drive turbine feature is utilized to determine the expected speed of the fan.

In another embodiment according to any of the previous embodiments, the expected speed of the fan is calculated based upon engine variables.

In another embodiment according to any of the previous embodiments, the engine is shut down should the sensed speed of the fan differ from the expected speed by more than a predetermined amount.

In another embodiment according to any of the previous embodiments, the control looks for progressive increase in the difference between the sensed speed and the expected speed.

In another embodiment according to any of the previous embodiments, an intermediate turbine is positioned between the first and fan drive turbines, and the intermediate turbine drives a compressor stage.

In another embodiment according to any of the previous embodiments, the speed reduction includes at least one of a flexible coupling and a spline connection to drive the fan.

In another embodiment according to any of the previous embodiments, the speed reduction directly drives the fan through a fan shaft.

In another featured embodiment, a gas turbine engine has a fan, a compression section including at least a first compressor and a second compressor downstream of the first compressor, a combustor, and a turbine system. The turbine system has a first turbine including a shaft to drive the second compressor, and at least a fan drive turbine. The fan drive turbine is operable to drive the fan through a speed reduction, an intermediate turbine positioned between the first and fan drive turbines. The intermediate turbine drives the first compressor. A sensor senses rotation information of the fan and communicates the sensed information to a control. The control is operable to develop expected information for the fan and identify a problem should the sensed information be different than the expected information by more than a predetermined amount. A sensor is associated with the fan drive turbine to sense rotation information of the fan drive turbine. Information relative to the fan drive turbine is utilized to determine the expected information of the fan. The engine is shut down should the sensed information differ from the expected information by more than a predetermined amount. The sensed rotation information is based upon a time of arrival of a feature that rotates with the fan. The expected speed is developed by sensing a time of arrival of a feature rotating with the fan drive turbine to develop said expected information.

In another embodiment according to the previous embodiment, the speed reduction includes at least one of a flexible coupling and a spline connection to drive the fan through the speed reduction.

In another embodiment according to any of the previous embodiments, the speed reduction directly drives the fan through a fan shaft.

In another featured embodiment, a method of operating a gas turbine engine includes a shaft driving a high compressor, and at least a fan drive turbine driving a fan through a speed reduction. A speed of rotation of the fan is sensed and compared to an expected speed for the fan. A problem is identified should the sensed speed of the fan be less than the expected speed by more than a predetermined amount.

In another embodiment according to the previous embodiment, the sensed speed of rotation of the fan is sensed by dynamically determining an angular position of a feature rotating with the fan by measuring the time of arrival of the feature. This dynamically determined angular position is utilized as the sensed speed, and compared to an expected angular position of the fan feature. The expected angular position is the expected speed.

In another embodiment according to any of the previous embodiments, the angular position of a feature rotating with the fan drive turbine is sensed and utilized to determine the expected angular position of the feature rotating with the fan.

In another embodiment according to any of the previous embodiments, the expected speed is calculated based upon engine variables.

In another embodiment according to any of the previous embodiments, if a progressive increase in the difference between the sensed speed and the expected speed, a problem is identified.

In another embodiment according to any of the previous embodiments, the fan drive turbine drives the fan. An intermediate turbine is positioned between the first and fan drive turbines. The intermediate turbine drives an intermediate compressor.

In another embodiment according to any of the previous embodiments, the speed reduction includes at least one of a flexible coupling and a spline connection to drive the fan through the speed reduction.

In another embodiment according to any of the previous embodiments, the speed reduction directly drives the fan through a fan shaft.

These and other features of this invention will be best understood from the following specification and drawings, the following of which is a brief description.

### BRIEF DESCRIPTION OF THE DRAWINGS

FIG. 1 schematically shows a first embodiment.

FIG. 2 schematically shows a second embodiment.

### DETAILED DESCRIPTION

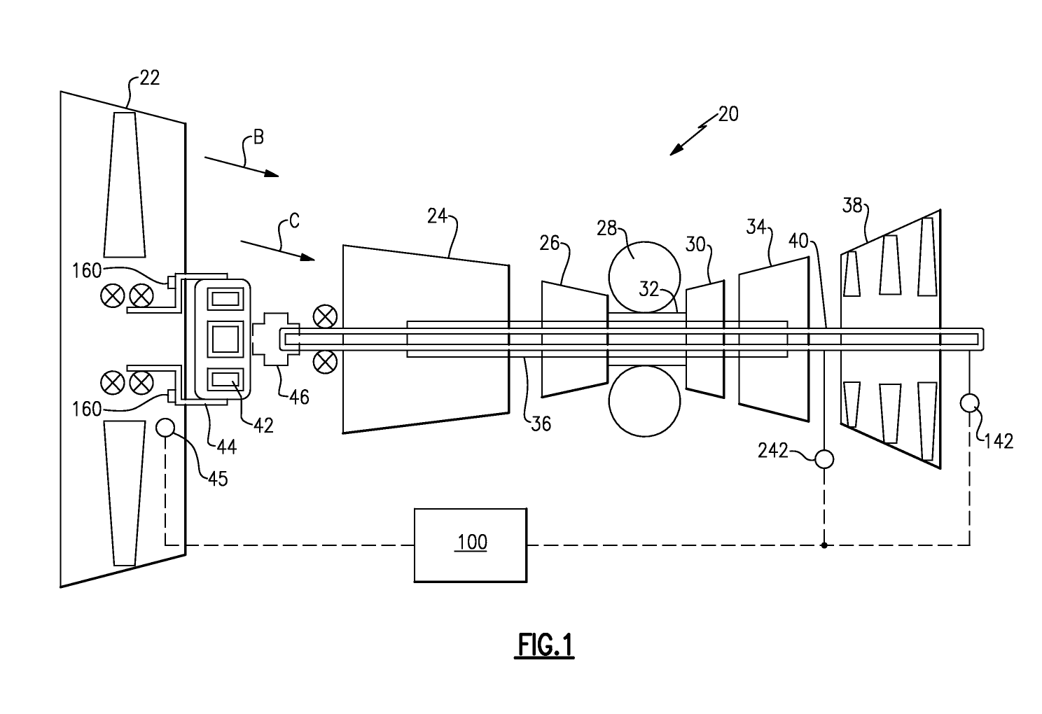

FIG. 1 shows a gas turbine engine 20 which has three spools. A fan 22 delivers bypass air B and core airflow C. The core airflow C passes into an intermediate pressure compressor 24. The air compressed by the intermediate pressure compressor 24 passes into a high pressure compressor 26. The air is compressed and delivered across a combustion section 28, where it is ignited. Products of this combustion pass downstream into a high pressure turbine 30. A high spool is defined by the high pressure turbine 30, which drives the shaft 32, which in turn drives the high pressure compressor 26.

The products of combustion pass downstream of the high pressure turbine 30 into an intermediate pressure turbine 34. The intermediate pressure turbine 34 drives a shaft 36, which in turn drives the intermediate pressure compressor 24 as an intermediate spool. From the intermediate pressure turbine 34 the products of combustion pass downstream over a low pressure turbine 38. The low pressure turbine 38 is driven to rotate, and in turn rotates the shaft 40. The shaft 40 drives a gear transmission 42 to rotate the fan 22. The speed reduction mechanism 42 is typically an epicyclic gear reduction unit, so that the fan rotates at a slower speed than the low pressure turbine 38, which is the fan driving turbine. As known, the terms “low,” “high,” and “intermediate” are relative to each other.

The gear transmission 42 includes gear components, and a coupling and/or a spline connection 46, shown somewhat schematically. This feature 46 may also be a flexible connection allowing for the engine to bend under thrust loads without causing mis-aligned input to the gearbox. In addition, the gear components 42 typically drive a fan shaft 44 which is connected to drive the fan 22. It will be understood that this figure is quite schematic, and a worker of ordinary skill in the art would recognize the types of flexible couplings, etc., along with the drive connections which may be used between these components.

As mentioned above, should any of the components 42/44/46 fail, then the low pressure turbine 38 might begin to rotate at undesirably high speeds, as it is no longer called upon to drive the fan rotor 22.

As used herein the term ‘speed’ is construed to mean the time at which an applicable engine component arrives at a particular rotation location, which arrival time may be compared to the time of arrival of another engine component. Similarly, the term ‘overspeed’ is construed to define the situation in which an applicable engine component arrives at a particular rotation location sooner than it should as compared to the arrival time of another component that is intended to have an arrival time that is historically consistent between the two features. Conversely, the term ‘underspeed’ is construed to define the situation in which an applicable engine component arrives at a particular rotation location later than it should as compared to the historical arrival time of another component. Also, the “term time of arrival” relates to the relative time of arrival of two features: a reference feature at one end of the spool assembly relative to a feature at or near the other end of the spool and this time of arrival difference can optionally be converted into a difference in the angular dimension of the two features.

More generally, the term “speed” can be taken to be any sort of rotation information with regard to the position of a feature rotating with the fan, and a way of reaching an expected value for that rotation information.

A sensor 45 is positioned adjacent blades of the fan rotor 22 or at the tip of the fan blades tip or at bumps or other features on the shaft 44 driving the fan hub. It should be understood that any type of sensor may be utilized, however, one disclosed sensor senses the time of arrival of an edge of the blades at their tip associated with the fan rotor 22. Such sensors are known, and have been utilized for any number of applications.

The time-of-arrival information from a sensor 45 is delivered to an electronic engine control 100. A second sensor 242 senses the time of arrival of bumps or other features on the shaft 40, and provides the information to the control 100. Again, any other type sensor may replace sensor 242 as long as the sensor and the accompanying control can precisely measure the time of arrival of a bump or other timing feature.

The sensor 242 is shown positioned on the shaft 40, and intermediate the low pressure turbine 38 and the gear connection 42. An alternative position 142 is shown on the opposed side of the shaft 40 from the low pressure turbine 38.

The control 100 takes in time of arrival information of each bump on the shaft individually from the sensor 45 and compares it to time of arrival of individual bumps or other timing features on the rotor from the sensor 242 or 142. The control 100 develops an expected time of arrival based upon the speed sensed by sensors 242/142 and a gear ratio across the speed reduction 42 (any, or all, of wind up produced in the shaft through normal idle, take-off, climb and cruise operation and also the transient wind up caused by power changes accelerations and decelerations may also be utilized).

The control 100 may be programmed to anticipate differences in the arrival time and speed providing for allowable shifts caused by power, ambient temperature, altitude, and creep. The control 100 may also be programmed to compensate for shaft windup due to torque levels, and with possible corrections for transient conditions such as the exertion of power and the time since such an exertion began. In addition, manufacturing tolerances and rotor assembly circumstances may be taken out at an engine's initial run, or after heavy maintenance, and thus are cancelled out or not interpreted as a concern.

The sensors 45, 142 and 242 may be any type of sensor. The locations may be as shown, however, any other location which is able to provide rotation information of the rotor 22, and a location on the opposed side of the gear connection 42 may be utilized.

If the arrival time or other rotation speed information of the fan 22 is significantly in error, then the engine may be shut down as a precaution should the turbine overspeed. If the arrival time of other speed information of the fan rotor 22 progressively becomes more and more different from that which is expected, the engine may be shut down or it may be flagged for inspection or maintenance. This decision may be made based on a rate of deterioration and the extent of the angular difference between the features ahead of and behind the gearbox.

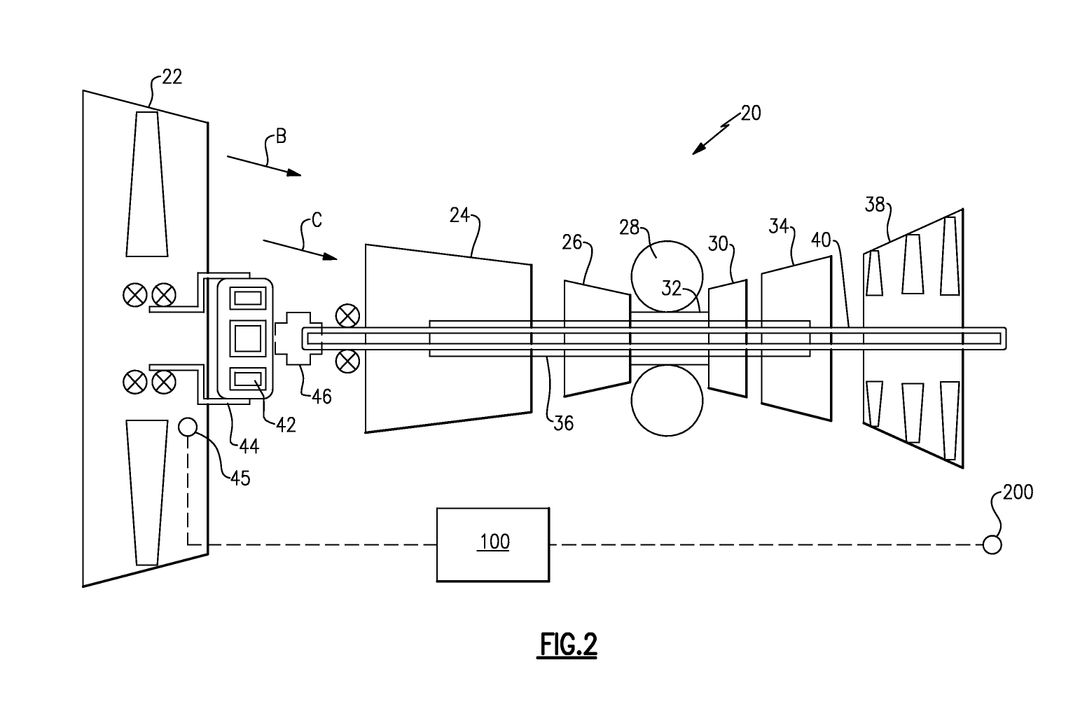

FIG. 2 shows an alternative embodiment, wherein a sensor 242 or 142 is not used. Instead, information 200 is utilized, which provides some other variable, which allows an expectation of the time of arrival or other speed to be seen by the sensor 45. As an example, the amount of fuel being delivered into the engine would provide an expected thrust level, and an expected speed of the fan. Any number of other engine related variables can be relied upon to provide this information such as fuel flow, high rotor speed, altitude, flight mach number and/or ambient temperature to provide the basis for calculating air flow and the input energy to the fan drive turbine and ultimately the fan across the gear system. Otherwise, the system will operate as in the first embodiment.

While a three spool design is shown it should be understood that the teachings may extend to a two spool design. In some respects, the teachings can extend to any number of gas turbine engine configurations, including a configuration which has a single compressor stage driven by a turbine stage with a fan drive turbine driving only a fan. Of course, the teachings would also extend to the standard two-spool design wherein the fan drive turbine also drives an intermediate or low stage compressor.

Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine comprising:
a fan;
a compressor section;
a combustor;
a turbine system, including a first turbine including a shaft to drive said compressor, and at least a fan drive turbine, said fan drive turbine being operable to drive said fan through a speed reduction; and
a sensor to sense a speed of rotation of said fan and communicate said sensed speed to a control, said control being operable to develop an expected speed for said fan and identify a problem should said sensed speed be less than the expected speed by more than a predetermined amount.

2. The gas turbine engine as set forth in claim 1, wherein said sensor dynamically determining an angular position of a feature rotating with the fan by measuring the time of arrival of the feature, and this dynamically determined angular position being utilized as the sensed speed, and compared to an expected angular position of the fan feature, said expected angular position being said expected speed.

3. The gas turbine engine as set forth in claim 1, wherein a sensor is associated with said fan drive turbine to sense the angular position of a feature on said fan drive turbine, and the sensed angular position of said fan drive turbine feature being utilized to determine said expected speed of said fan.

4. The gas turbine engine as set forth in claim 1, wherein the expected speed of said fan is calculated based upon engine variables.

5. The gas turbine engine as set forth in claim 1, wherein said engine is shut down should said sensed speed of said fan differ from said expected speed by more than a predetermined amount.

6. The gas turbine engine as set forth in claim 1, wherein said control looks for progressive increase in the difference between the sensed speed and the expected speed.

7. The gas turbine engine as set forth in claim 1, wherein an intermediate turbine is positioned between said first and fan drive turbines, and said intermediate turbine drives a compressor stage.

8. The gas turbine engine as set forth in claim 1, wherein said speed reduction includes at least one of a flexible coupling and a spline connection to drive said fan.

9. The gas turbine engine as set forth in claim 8, wherein said speed reduction directly drives said fan, through a fan shaft.

10. A gas turbine engine comprising:
a fan;
a compression section, including at least a first compressor and a second compressor downstream of said first compressor;
a combustor;
a turbine system, including a first turbine including a shaft to drive said second compressor, and at least a fan drive turbine, said fan drive turbine being operable to drive said fan through a speed reduction, an intermediate turbine positioned between said first and fan drive turbines, and said intermediate turbine drives said first compressor;
a sensor to sense rotation information of said fan and communicate said sensed information to a control, said control being operable to develop expected information for said fan and identify a problem should said sensed information be different than the expected information by more than a predetermined amount;
a sensor associated with said fan drive turbine to sense rotation information of said fan drive turbine;
information relative to said fan drive turbine being utilized to determine said expected information of said fan; and
said engine being shut down should said sensed information differ from said expected information by more than a predetermined amount, and said sensed rotation information being based upon a time of arrival of a feature that rotates with said fan, and said expected speed being developed by sensing a time of arrival of a feature rotating with said fan drive turbine to develop said expected information.

11. The gas turbine engine as set forth in claim 9, wherein said speed reduction includes at least one of a flexible coupling and a spline connection to drive said fan through said speed reduction.

12. The gas turbine engine as set forth in claim 11, wherein said speed reduction directly drives said fan through a fan shaft.

13. A method of operating a gas turbine engine comprising:
a turbine system having a first turbine including a shaft driving a high compressor, and at least a fan drive turbine driving a fan through a speed reduction; and
sensing a speed of rotation of said fan and comparing a sensed speed to an expected speed for said fan and identifying a problem should said sensed speed of said fan be less than the expected speed by more than a predetermined amount.

14. The method as set forth in claim 12, wherein said sensed speed of rotation of said fan is sensed by dynamically determining an angular position of a feature rotating with the fan by measuring the time of arrival of the feature, and this dynamically determined angular position being utilized as the sensed speed, and compared to an expected angular position of the fan feature, the expected angular position being said expected speed.

15. The method as set forth in claim 14, wherein sensing the angular position of a feature rotating with said fan drive turbine, and said sensed angular position of said feature on said fan drive turbine being utilized to determine said expected angular position of said feature rotating with said fan.

16. The method as set forth in claim 14, wherein the expected speed is calculated based upon engine variables.

17. The method as set forth in claim 13, wherein if a progressive increase in the difference between the sensed speed and the expected speed is determined, a problem is identified.

18. The method as set forth in claim 12, wherein said fan drive turbine drives said fan, and an intermediate turbine is positioned between said first and fan drive turbines, and said intermediate turbine drives an intermediate compressor.

19. The method as set forth in claim 12, wherein said speed reduction includes at least one of a flexible coupling and a spline connection to drive said fan through said speed reduction.

20. The method as set forth in claim 19, wherein said speed reduction directly drives said fan through a fan shaft.

21. A gas turbine engine comprising:
a fan and a fan drive turbine for driving said turbine through a speed reduction; and
a sensor for sensing speed of rotation of said fan, and communicating said sensed speed to a control, said control configured for determining an expected speed for said fan and identifying when said sensed speed differs from said expected speed by more than a predetermined amount.
